(19) United States
(12) Patent Application Publication
(10) Pub. No.: US 2026/0337016 A1
(43) Pub. Date: Oct. 29, 2026

(54) LOW PRESSURE AMMONIA CRACKING AND HYDROGEN SEPARATION

(71) Applicant: Saudi Arabian Oil Company, Dhahran (SA)

(72) Inventors: Osamah Siddiqui, Khobar (SA); Abdulrahman S. Alsuhaibani, Dammam (SA); Aqil Jamal, Dhahran (SA); Bandar H. Solami, Dammam (SA)

(21) Appl. No.: 19/186,948

(22) Filed: Apr. 23, 2025

(51) Int. Cl. C01B 3/047; C01B 3/508; C25B 1/02; C25B 15/08

(52) U.S. Cl. CPC C01B 3/047; C01B 3/508; C25B 1/02; C25B 15/083; C01B 2203/042; C01B 2203/066; C01B 2203/0838; C01B 2203/085; C01B 2203/84

(57) ABSTRACT

Ammonia is decomposed in an electric reactor at a low pressure to produce a mixture of hydrogen (H₂) and nitrogen (N₂). The electric reactor is powered by an electrical energy input produced by a direct ammonia fuel cell (DAFC). The DAFC uses unreacted ammonia from the decomposition reaction as a fuel source to produce electrical energy. After the decomposition of ammonia, H₂ and N₂ gas mixture is separated at a low pressure using a vacuum thermal swing adsorption (VTSA) subsystem, without requiring further gas compression. The VTSA subsystem uses vacuum and thermal energy recovered by a waste heat recovery system to desorb N₂, resulting in an effluent stream of H₂. A portion of the electrical energy from the DAFC is used to operate the VTSA subsystem.

### TECHNICAL FIELD

This disclosure relates to methods of gas decomposition and separation.

### BACKGROUND

Ammonia is used as a carrier to store and transport hydrogen (H₂) due to its higher volumetric density and storage capacity compared to gaseous H₂. The use of ammonia is also effective for producing H₂ on-site. Ammonia cracking is a process in which ammonia is decomposed into nitrogen (N₂) and H₂. Conventional ammonia cracking systems utilize pressure swing adsorption (PSA) for the separation of H₂. The produced H₂is used as a fuel or an industrial chemical, for example, in methanol production.

### SUMMARY

Implementations described here provide a method and system for low pressure ammonia cracking and hydrogen separation.

### BRIEF DESCRIPTION OF DRAWINGS

FIG. 1 is a schematic representation of an example of an ammonia cracking system using an electric reactor and a vacuum temperature swing adsorption (VTSA) subsystem.

FIG. 2 is a schematic representation of an example of an ammonia cracking system using a membrane reactor and a VTSA subsystem.

FIG. 3 is a flow chart of an example of a process for ammonia cracking and gas separation.

### DETAILED DESCRIPTION

Hydrogen is used as a raw material in several industrial applications, such as the production of methanol, fertilizers, fuel cells, and metal alloying. H₂ at a high pressure is used for fuel cell vehicles, hydrogen fueling stations, and portable power generation. High pressure H₂ is obtained from cracking high pressure ammonia (ammonia at 290-725 psi (2-5 Mega Pascals (MPa))). In several industrial applications, H₂ is not needed at high pressures. In such cases, low pressure H₂ can be utilized to meet such demands. Low pressure H₂ can be obtained from cracking low pressure ammonia.

In low-pressure ammonia cracking systems, separating H₂ from the cracked (decomposed) gas mixture is challenging when using a PSA system. When PSA systems are used to separate H₂ from the gas mixture, a compressor is used to increase the pressure of the inlet gas mixture to the PSA system to about 145-580 pounds per square inch (psi) (0.9-4 MPa) continuously throughout the separation process. Doing so increases the energy requirements for the separation process and reduces the overall efficiency of the system. Further, ammonia cracking systems include a gas fired reactor to heat the ammonia for decomposition. The use of a gas fired reactor can lead to convective and radiation heat losses, thereby resulting in uneven heat distribution within the reactor. This uneven heat distribution can reduce the yield of the H₂ and N₂, the byproducts of ammonia decomposition.

Implementations disclosed here provide an integrated system and method for efficiently decomposing low pressure ammonia to produce a low pressure H₂ with high purity. The integrated system includes an electric reactor for ammonia decomposition, a VTSA subsystem for gas separation which is coupled to a waste heat recovery unit, and a direct ammonia fuel cell (DAFC) which uses unreacted residual ammonia for producing electrical energy. At least a portion of the electrical energy is used to operate the electric reactor and the VTSA subsystem.

In the integrated system, an electric reactor is used for ammonia decomposition, as the electrically powered reactor results in uniform heat distribution within the reactor. The uniform heat distribution leads to a high yield of byproducts, with ammonia conversion rates ranging from 95-99%. In some implementations, a membrane reactor is used for ammonia decomposition instead of an electric reactor, which is also powered by electrical energy. The membrane reactor includes an in-situ separation of H₂ as a result of an electrochemical process. Both the electric reactor and the membrane reactor are powered by the electrical energy generated by the DAFC.

The VTSA subsystem is used to separate the effluent gas mixture from the reactor to produce low pressure H₂. A portion of the electrical energy from the DAFC is used to operate the VTSA subsystem. In addition to the electrical energy, the waste heat recovery unit coupled to the VTSA subsystem provides thermal energy for the desorption process.

The integrated system provides an energy efficient process to decompose low pressure ammonia and separate the effluent gas mixture to provide low pressure H₂ and N₂ gases. Further, the VTSA subsystem does not need a compressor to increase the inlet gas pressure during the adsorption process. The VTSA uses vacuum only for the desorption step, thereby making the process energy efficient. The integrated system includes a waste heat recovery that is utilized during the desorption step, thereby avoiding additional external heating load. In addition, the integrated system utilizes the unreacted ammonia along with fresh ammonia feed in a DAFC to produce electrical power that is used for operating the electric reactor. The use of the DAFC powered electric reactor avoids emissions, during the generation of thermal energy for the endothermic ammonia cracking reaction.

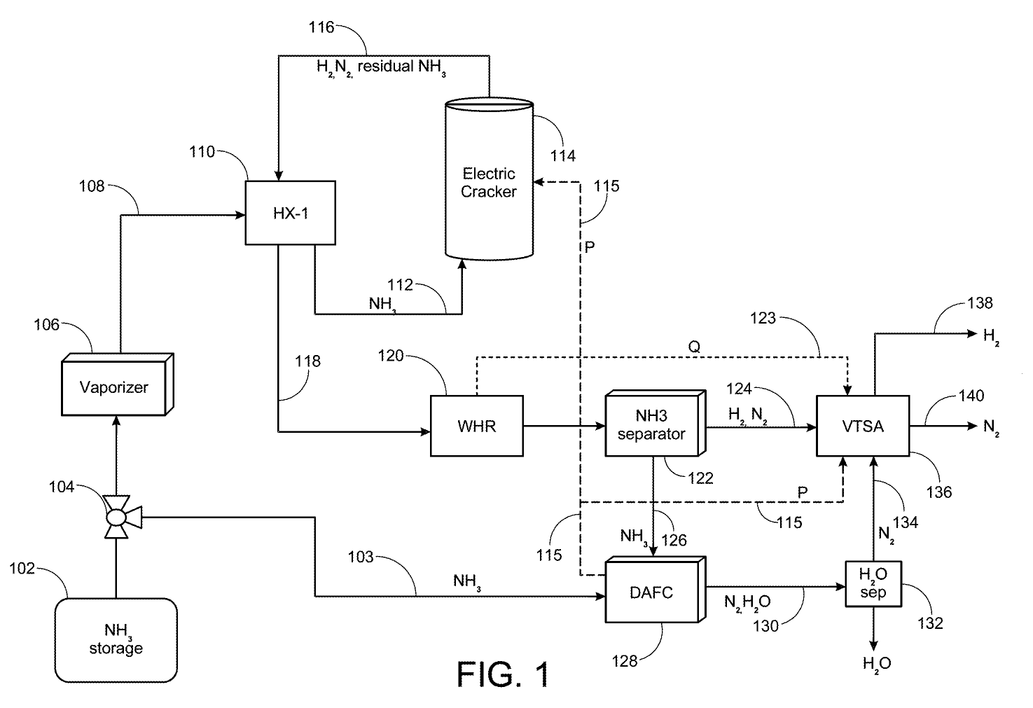

FIG. 1 is a schematic representation of an example of an ammonia cracking system using an electric reactor and vacuum temperature swing adsorption (VTSA). Ammonia is stored in a storage tank 102 as a liquid or a mixture of liquid and gaseous phase, for example, at a temperature of about -20 to 20°C. The storage temperature depends on the storage pressure. For example, if the storage pressure is 14.7 psi (0.1 MPa), ammonia can be stored as a liquid at a temperature of -20°C to -30°C. At a storage pressure of about 30-100 psi (0.2-0.7 MPa), ammonia can be stored as a liquid at a temperature of -26°C to 14°C. At similar pressures of 30-100 psi (0.2-0.7 MPa), ammonia can be stored as a mixture of liquid and gas at room temperature or higher. The storage tank 102 is a cylindrical vessel equipped with flow control valves.

A liquid pump flows liquid ammonia through a valve 104 towards a vaporizer 106. The vaporizer 106 includes a series of heat exchangers to provide heat to the incoming liquid ammonia stream. The vaporizer 106 can include a heat source such as hot water or steam. The liquid ammonia stream is heated to a temperature of 50-80°C (above ammonia’s boiling point which depends on the storage pressure) in the vaporizer 106 to form a gaseous ammonia stream 108. The gaseous ammonia stream 108 exiting the vaporizer 106 has a low pressure ranging between 7-45 psig (0.05-0.3 MPa). The pressure of the gaseous ammonia stream 108 exiting the vaporizer 106 can be controlled to meet the requirements of the reactor’s 114 operating pressure.

The gaseous ammonia stream 108 is directed towards a first heat exchanger 110 through a gas flow pathway (e.g., tubing system). The gas flow pathway is equipped with flow control valves and pressure regulators. The gas flow pathways direct gas flow to the various components in the system. The first heat exchanger 110 increases the temperature of the gaseous ammonia stream 108 by using the recovered heat from the effluent stream of the reactor 114. The increased temperature of the gaseous ammonia stream 108 makes the process energy efficient as the gaseous ammonia stream uses less energy within the reactor 114. The temperature of the effluent gaseous ammonia stream 112 from the first heat exchanger 110 is about 300-450°C. The pressure of the effluent gaseous ammonia stream 112 is about 7-45 psi (0.04-0.3 MPa).

The effluent gaseous ammonia stream 112 from the first heat exchanger 110 flows through an ammonia feed line to the reactor 114. The ammonia feed line is a tubular structure which includes a pressure regulator coupled with a mass flow controller to maintain the pressure of the gaseous ammonia stream at a value of about 7-45 psi (0.05-0.3 MPa). The mass flow controller regulates the gaseous ammonia flow rate. The ammonia flow rate depends on the process to which hydrogen is fed. For example, the ammonia flow rate can vary between 100-2000 kg/day to about 1000 tonnes/day. The pressure regulator and the mass flow controller ensure a steady and low pressure gaseous ammonia feed to the reactor 114.

The reactor 114 is a cylindrical vessel which has an inlet port and an outlet port. The reactor 114 can be made of Inconel alloy material or alumina/ceramic coated stainless steel. The inlet port receives the gaseous ammonia feed and the outlet port discharges the byproducts of the ammonia cracking reaction. The reactor 114 includes a packed bed electric reactor which is equipped with heating elements. In some implementations, a multitubular reactor equipped with heating elements is used. The reactor 114 can include about 10-50 heating elements installed on the surface of the wall or embedded in the wall of the reactor 114. The heating elements can include coils, spirals, u-shaped tubes, or straight tubes which are covered by special insulation material such as ceramic materials or aluminum coating. The heating elements receive electrical energy 115 input from a DAFC 128 to generate heat by resistive heating. The heat generated is used for the ammonia cracking (decomposition) reaction. In some implementations, heat is generated in the reactor 114 by inductive heating.

Inductive heating of the reactor 114 refers to heating achieved via electromagnetic induction. The reactor 114 vessel can be made from electrically conductive or magnetic materials (e.g., stainless steel, hastealloy, etc.). The induction coil can include materials having good electrical conductivity, such as copper-based tubing. When an alternating current is passed through the induction coil, it creates a rapidly changing electromagnetic field around the coil. The alternating magnetic field also keeps penetrating the reactor walls that are made of conductive material. The changing magnetic fields induce electrical currents that produce heat when they encounter electrical resistance. In addition, if ferromagnetic materials are utilized, heat generation also arises from the magnetization and demagnetization cycles. In some implementations, a portion of the electrical energy is supplied by an external circuit.

The electric reactor can provide better heat transfer and temperature profiles across the reactor when compared to a gas fired reactor. The use of an electric reactor minimizes heat losses by directly generating heat in the reactor 114 and providing a uniform heat distribution within the reactor 114. Using an electric reactor eliminates the need to transfer heat through pipes and other media to the reactor 114, which typically results in convective and radiation heat losses.

The reactor 114 is packed with a catalyst, such as cobalt-based catalysts (e.g., barium-cobalt-cerium (BaCoCe) catalyst), nickel-based catalysts, or ruthenium-based catalysts. The catalyst can be coated on the contact surfaces inside the reactor 114. The catalyst can also include pellets/tablets which are placed between the heating elements in the reactor 114. The catalyst is used to increase the rate of the ammonia cracking reaction and improve the conversion rate. Ammonia conversion in low-pressure cracking processes can be 95-99%, which depends on the type of catalyst used. Both rutheium based and BaCoCe based catalyst can provide a high conversion rate.

Ammonia cracking is a process by which gaseous ammonia is decomposed into H₂and N₂. Ammonia cracking is an endothermic reaction, which occurs at a temperature range of 550-700°C. After gaseous ammonia is decomposed, an effluent stream 116 that includes H₂, N₂, and residual unreacted ammonia flows towards the first heat exchanger 110. The effluent stream 116 is cooled to a temperature of 200-450°C by exchanging heat with an incoming gaseous ammonia stream 108.

The effluent gas stream 118 from the first heat exchanger 110 flows towards a waste heat recovery unit (WHR) 120, where the effluent gas stream 118 is further cooled to a temperature of 20-40°C. The waste heat recovery unit 120 includes multiple heat exchangers connected in series or parallel. The heat exchanger can include shell and tube exchangers, fin heat exchangers, or plate heat exchangers. The heat exchanger includes a coolant such as water or air for the heat transfer process. Waste heat from the effluent gas stream 118 is recovered while cooling the stream and the waste heat is utilized to provide thermal energy 123 for operations in the VTSA subsystem 136.

The effluent gas stream 118, after being cooled in the WHR 120 is directed to an ammonia separator subsystem 122, where unreacted ammonia is separated from the remaining gas mixture. The ammonia separator subsystem 122 includes sorbent beds of material that selectively adsorb ammonia (Example: calcium or sodium-based molecular sieves). The beds sequentially adsorb and desorb ammonia. For example, if a four-bed system is used, two beds will adsorb while two beds will desorb simultaneously. In the next cycle, the beds that desorbed ammonia will be used for the adsorption of ammonia while the other two beds will undergo desorption simultaneously. The remaining un-adsorbed H₂ and N₂ exit the separator subsystem via stream 124. The ammonia adsorbed in the ammonia separator is desorbed via heating of the sorbent. The desorbed ammonia stream 126 is sent to the 128 (DAFC). The H₂ and N₂ gas mixture 124 from the ammonia separator subsystem 122 is directed towards the VTSA subsystem 136. The pressure of the gas mixture 124 is 7-45 psig (0.05-0.3 MPa).

The desorbed ammonia stream 126 from the ammonia separator subsystem 122 is used as a fuel source in a DAFC 128. In some implementations, ammonia 103 from the storage tank 102 is also used as a fuel source in the DAFC 128, in addition to the desorbed ammonia stream 126. The pressure of the ammonia 103 is controlled between 15-45 psi (0.103-0.31 MPa). The desorbed ammonia stream 126 will be regulated to match the pressure of the stream of ammonia 103.

The DAFC 128 includes an anode, cathode, and an electrolyte. Further, the DAFC 128 includes an air inlet port and air outlet port. Different types of DAFCs can be used and the materials used for each type of DAFC can vary. For example, if a solid oxide fuel cell is utilized with an oxygen anion conducting electrolyte, the anode material can include nickel on Yttria-stabilized zirconia. The cathode can include lanthanum strontium manganite (LSM) and the electrolyte can include yttria-stabilized zirconia. If an alkaline DAFC is used, the anode can include platinum-based or nickel-based catalysts. The cathode can include platinum-ruthenium-based catalysts and the electrolyte can include anion exchange membranes or potassium hydroxide solution.

Desorbed ammonia stream 126 is directly fed to the anode of the DAFC 128. If a solid oxide fuel cell based DAFC is used with an oxygen anion conducting electrolyte, ammonia is oxidized by an electrochemical reaction at the anode to produce electrons, N₂, and H₂O. At the cathode, oxygen from the air is reduced by the electrons to produce oxygen ions (O²⁻). As the electrons flow from the anode side to the cathode side, electrical energy 115 is produced. At least a portion of the electrical energy 115 is transmitted through an external wiring system to power the reactor 114. Another portion of the electrical energy 115 is transmitted through the external wiring system to the VTSA subsystem 136.

The external wiring system can include wires, bus bars, and insulated cables. Bus bars are heavy duty conductive bars that collect current from the DAFC 128. The external wiring system can also include a bi-directional power controller to assess in which direction electrical energy 115 flows. The wires and cables for the external wiring system can be made from copper or aluminum.

The N₂gas and water mixture 130 produced due to the electrochemical reaction is vented out of the DAFC 128 through an exit port and directed to a water separator 132. In the water separator 132, the N₂ gas and water mixture 130 is cooled down to condense and separate water. The N₂ gas is vented out from the water separator 132 and directed as a N₂stream 134 towards the VTSA subsystem 136.

The VTSA subsystem 136 receives the H₂ and N₂ gas mixture 124 (pressure 7-45 psi (0.05-0.3 MPa)) from the ammonia separator subsystem 122. The H₂ and N₂ gas mixture 124 includes 75% molar fraction (mol) of H₂ and 25 mol% of N₂. The VTSA subsystem 136 is utilized for the separation of the gas mixture to produce high purity H₂ gas (90-99%) and N₂ gas.

The VTSA subsystem 136 includes an adsorption-based separation process. In some implementations, the VTSA subsystem includes an absorption-based separation process, where water or organic solvents are used for the absorption process. The adsorption-based process includes multiple adsorption beds, a vacuum pump to generate vacuum during the desorption process, a heating system, and flow valves to direct gas flow. In some implementations, a single adsorbent bed is utilized for the gas separation process. The adsorbents used in the adsorption beds include carbon molecular sieves, zeolites, or metal oxide frameworks (MOFs).

The low pressure H₂ and N₂ gas mixture 124 flows towards the adsorption bed in the VTSA subsystem 136 at a pressure of 7-45 psi (0.05-0.3 MPa). No further compression of the H₂ and N₂ gas mixture 124 is needed for the separation process. The adsorbent selectively captures N₂ in its pore space due to the size and selectivity of the adsorbent material. As the N₂ gas molecules are trapped in the adsorbent material, the H₂ gas molecules are separated from the gas mixture, resulting in the separation of a low pressure H₂ gas stream 138. The low pressure H₂ gas stream 138 is directed by a flow valve to exit the VTSA subsystem 136.

To separate the adsorbed N₂, the adsorption bed is heated to desorb (release) the trapped N₂ molecules. The process of desorbing the N₂ molecules results in regenerating the adsorption bed, which can be used to begin a new adsorption-desorption cycle. Heat and vacuum are utilized for the desorption process. The desorption process utilizes thermal energy 123 provided by the WHR unit 120 as the source of heat. The WHR unit 120 is coupled to the VTSA subsystem 136 by an insulated tubing system to minimize heat losses. The waste heat from the WHR unit 120 can be transferred to the VTSA subsystem 136 via a heating fluid (water or oil) in coils or tubing. The heating fluid absorbs the thermal energy released in the WHR unit 120 and transfers it to the VTSA subsystem 136 via an insulated tubing. In some implementations, thermal energy is also supplied by another source such as an electric heater, a microwave heater, or a circulating fluid, such as steam or hot water. In some implementations, the thermal energy 123 from the WHR unit 120 is used as a supplemental energy to reduce the thermal energy provided by other sources.

Further, the desorption process utilizes vacuum. Vacuum is used only for the desorption process and not the adsorption process, thereby making the operation of the process energy efficient. A portion of the electrical energy 115 provided by the DAFC 128 is used for operating the vacuum pump in the VTSA subsystem 136 for vacuum generation. The electrical energy 115 can also be used for the operation of other components in the VTSA subsystem 136.

The temperature for regenerating the adsorption bed depends on the adsorbent material. If carbon molecular sieves are used as the adsorbent material, the temperature for regeneration ranges between 100-250^{o}C along with a vacuum pressure of nearly 1.4-7 psi (0.01-0.05 MPa) below atmospheric pressure. If zeolites are used as the adsorbent material, the temperature for regeneration ranges between 100-300^{o}C with the vacuum pressure of nearly 1.4-7 psi (0.01-0.05 MPa) below atmospheric pressure. If MOFs are used as the adsorbent material, the regeneration temperature ranges between 80-120^{o}C with the vacuum pressure of nearly 1.4-7 psi (0.01-0.05 MPa) below atmospheric pressure.

After the desorption of N₂ molecules, a N₂ gas stream 140 exits the VTSA subsystem 136. To further cool the adsorption bed after regeneration, N₂ stream 134 from the water separator 132 is used. The adsorption bed is regenerated and can be used for another cycle of adsorption-desorption process.

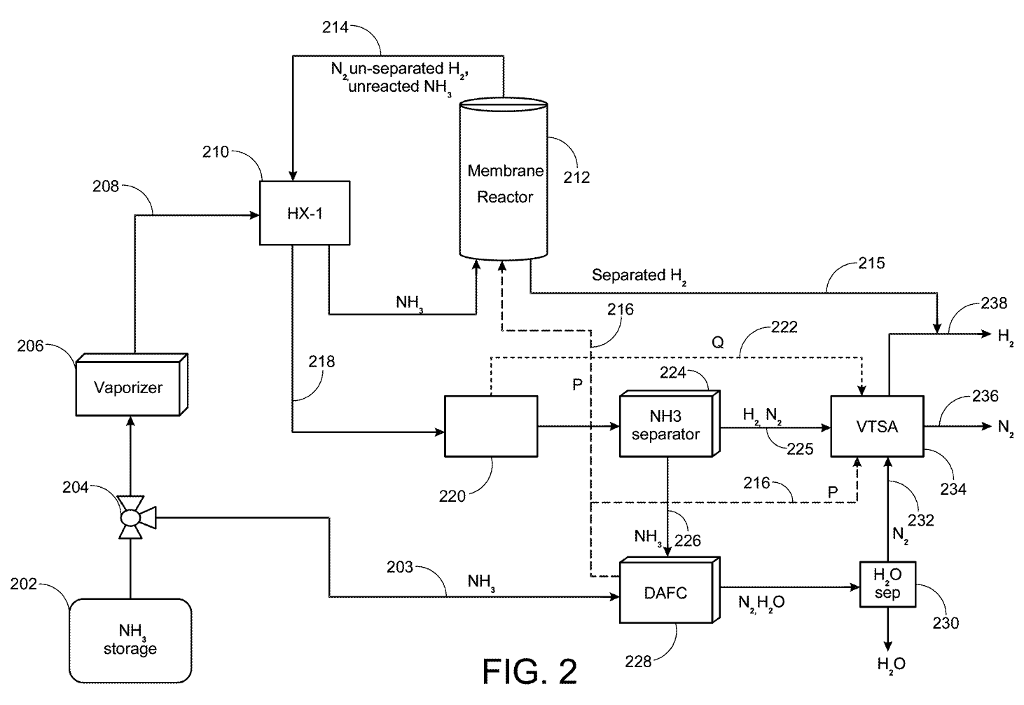

FIG. 2 is a schematic representation of an example of an ammonia cracking system using a membrane reactor and vacuum temperature swing adsorption (VTSA). As described in FIG. 1, ammonia is stored in a storage tank 202. The temperature of the storage tank can range between -20 to 20°C and the pressure can range between 70-100 psi (0.4-0.7 MPa). Ammonia storage temperature is dependent on the storage pressure. Liquid ammonia flows from the storage tank 202 through a flow valve 204 to a vaporizer 206. A liquid pump flows the liquid ammonia to the vaporizer 206.

The vaporizer 206 converts liquid ammonia into gaseous ammonia. The vaporizer 206 can include a cylindrical vessel with a heating element, such as steam jacket or electric heater. The heat provided by the heating element is used for liquid ammonia vaporization, resulting in gaseous ammonia. The gaseous ammonia stream that exits the vaporizer 206 has a temperature of about 50-80°C and a pressure of about 7-45 psi (0.05-0.3 MPa). The pressure of the gaseous ammonia stream exiting the vaporizer is lower than conventional high-pressure gaseous ammonia stream.

Gaseous ammonia from the vaporizer 206 is directed towards a first heat exchanger 210 through gas flow pathways (tubing system). As described in FIG. 1, the first heat exchanger 210 increases the temperature of the gaseous ammonia by using the recovered heat from the effluent stream of the reactor 212. The gaseous ammonia stream that exits the first heat exchanger 210 has a temperature of 300-450^{o}C and a low pressure ranging between 7-45 psi (0.05-0.3 MPa). The low-pressure gaseous ammonia flows through a feed line to the inlet of the reactor 212. The feed line is equipped with a pressure regulator to control the gaseous ammonia feed pressure, ensuring that the pressure is between 7-45 psi (0.05-0.3 MPa). Further, the mass flow controller installed on the feed line controls gaseous ammonia feed flow rate. The ammonia feed flow rate depends on the process to which hydrogen is supplied. The feed flow rate can range between 100-2000 kg/day for small scale plants. For large scale plants, the feed flow rate can range between 1000-5000 tonnes/day.

The reactor 212 includes a protonic membrane reactor. The reactor 212 vessel’s outer shell can be made from Inconel alloy material or alumina/ceramic coated stainless steel. A protonic membrane reactor is a cylindrical vessel that is installed within the reactor 212. The protonic membrane reactor combines a chemical reaction with a membrane separation process in a single unit, allowing for selective removal of reaction products as they are formed. The membrane separation process is driven by an electrochemical process, enhancing the overall reaction yield. The proton membrane reactor includes an anode, cathode, and electrolyte. The anode and cathode can include transition metals or combination of transition metals and noble metals such as platinum-nickel or ruthenium-nickel. In some implementations, nickel on the anode acts as the catalyst. The electrolyte can include proton conducting ceramics, for example, barium-ceria-based materials.

The reactor 212 includes an inlet and an two outlets. A proton (H⁺) conducting membrane is installed in the protonic membrane reactor, which divides the proton membrane reactor into a reaction zone and a electrochemical separation zone. The proton conducting membrane is a thin cylindrical sheet (tube like structure) installed along the axis of gas flow. The outer diameter of the proton conducting membrane is smaller than the reactor’s 212 inner diameter, such that the outer space surrounding the proton conducting membrane is the reaction zone (anodic side). The proton conducting membrane can be supported on a ceramic material and can include barium-ceria-based or barium-zirconia based materials, such as barium-zirconium-ceria-yttrium (BZCY) or barium-ceria-yttrium (BCY). The proton conducting membrane selectively lets H⁺ pass through it (permeate) and prevents N₂ and other components from passing through it (retentate). The space enclosed within the proton conducting membrane (cathodic side) is connected to a first outlet of the reactor 212 to flow the separated H₂ gas. The anodic side is on the reaction zone of the protonic membrane reactor, where the H₂ gets converted to H⁺ ions by losing of electrons. The cathodic side is on the permeate side where the H⁺ ions are converted back to H₂.

Gaseous ammonia flows through the inlet port of the reactor 212. Decomposition of gaseous ammonia takes place at a temperature of 550-700°C in the reaction zone of the reactor 212. The decomposition reaction results in N₂, H₂, and unreacted ammonia. The H₂ molecules formed in the reaction zone are electrochemically converted into H⁺ ions. The H⁺ ions pass through the proton conducting membrane to reach the electrochemical separation zone where the H⁺ converts back to H₂ molecules in-situ and are separated from the reaction zone. The electrochemically separated H₂ stream 215 flows out of the reactor through the first outlet port. The other gases, such as N₂, unreacted ammonia, and the H₂ that does not pass through the proton conducting membrane are discharged through a second outlet port of the reactor 212 as an effluent stream 214.

The overall chemical reaction occurring in the reaction zone is:

NH₃ 0.5 N₂ + 1.5 H₂ R.1

The electrochemical reaction at the anodic side is:

H₂ 2H⁺ + 2e⁻ R.2

The electrochemical reaction at the cathodic side is:

2H⁺ + 2e⁻ H₂ R.3

The heat (thermal energy) for the ammonia decomposition reaction in the reactor 212 is obtained by using at least a portion of the electrical energy 216 provided by the DAFC 228. The electrical energy 216 from the DAFC 228 is also used for the electrochemical separation of H₂ by the membrane separation process. In some implementations, electrical energy is supplied from an external circuit to supplement the electrical energy provided by the DAFC 228.

After the decomposition of ammonia, the effluent stream 214 flows to the first heat exchanger 210 through a gas flow pathway (tubular systems). The gas flow pathway is equipped with pressure regulators and flow valves. The effluent stream 214 is cooled to a temperature of about 200 - 450^{o}C, by exchanging heat with the incoming gaseous ammonia stream 208. The gas mixture stream 218, after being cooled, flows towards a WHR unit 220. As described in FIG. 1, the WHR unit includes multiple heat exchangers connected in series or parallel. The gas mixture stream 218 is further cooled to a temperature of about 20-40°C in the WHR unit 220. As the gas mixture stream 218 is cooled, the waste heat is recovered, which is used to provide thermal energy 222 to the VTSA subsystem 234.

The gas mixture stream 218 flows towards an ammonia separator subsystem 224 through a gas flow pathway. The ammonia separator subsystem 224 includes a sorbent bed of material that selectively adsorbs ammonia (e.g., calcium or sodium-based molecular sieves), resulting in a separated ammonia stream 226. The remaining un-adsorbed H₂ and N₂ exit the ammonia separator subsystem 224 as stream 225. The remaining H₂ and N₂ gas mixture 225 flows as an effluent stream from the ammonia separator 224 to the VTSA subsystem 234.

The separated ammonia stream 226 is used as a fuel for operating the DAFC 228 to produce electrical energy 216 by an electrochemical reaction. In addition to the separated ammonia stream 226, ammonia stream 203 from the storage tank 202 is also used to provide fuel for the DAFC 228. As described in FIG. 1, the DAFC 228 includes a chamber in which an anode, a cathode, and an electrolyte are placed. Different types of DAFCs can be used and the materials used for each type of DAFC can vary. For example, if a solid oxide fuel cell is utilized with an oxygen anion conducting electrolyte, the anode material can include nickel on yttria-stabilized zirconia. The cathode can include lanthanum strontium manganite (LSM) and the electrolyte can include yttria-stabilized zirconia. If an alkaline DAFC is used, the anode can include platinum-based or nickel-based catalysts. The cathode can include platinum-ruthenium-based catalysts and the electrolyte can include anion exchange membranes or potassium hydroxide solution. The DAFC 228 also includes an inlet port for air and an outlet port to vent out excess air. If a solid oxide fuel cell based DAFC is utilized with an oxygen anion conducting electrolyte, ammonia is oxidized by an electrochemical reaction to produce electrons, N₂, and H₂O at the anode to produce electrons, N₂, and H₂O. At the cathode, oxygen from the air is reduced by the electrons to produce oxygen ions (O²⁻). As the electrons flow from the anode to the cathode, electrical energy 216 is produced. The electrical energy 216 is transmitted by an external circuit to power the reactor 212 and the VTSA subsystem 234.

At the end of the electrochemical reaction, a mixture of N₂ and water are formed on the anode side. The mixture of N₂ and water is directed to a water separator 230. Water is separated out by cooling the mixture and condensing it. N₂ remains in the gaseous form and flows as an N₂ gas stream 232, which is used as a cooling medium for the VTSA subsystem 234.

The VTSA subsystem 234 receives the H₂ and N₂ gas mixture 225 at a low pressure of about 7-30 psi (0.04-0.2 MPa) from the ammonia separator 224. No further compression of the H₂ and N₂ gas mixture 225 is performed. The gas mixture includes about 75 mol% of H₂ and 25 mol% of N₂. The VTSA subsystem 234 can include an adsorption-based process or an absorption-based process. In an adsorption-based process, as described in FIG. 1, the VTSA subsystem 234 includes multiple adsorption beds, a vacuum generation pump, a heating system, and flow valves to direct gas flow. In some implementations, a single adsorption bed is used for the gas separation process. The adsorption beds in the VTSA subsystem 234 can include adsorbent materials such as carbon molecular sieves, zeolites, and MOFs. The adsorbent materials are selected based on the pore size and gas selectivity.

The H₂ and N₂ gas mixture 225 flows to the adsorption bed in the VTSA subsystem 234 through a gas flow pathway. The N₂ gas from the mixture is selectively adsorbed by the adsorbent bed due to the pore size and selectivity of the adsorbent material. Adsorption of N₂ results in the separation of almost pure H₂ stream 238 ( 90-99% purity). After separation, the H₂ stream 238 is combined with the electrochemically separated H₂ stream 215 from the reactor 212 to form a combined low pressure H₂ stream. The combined H₂ stream has a pressure ranging between 7-30 psi (0.04-0.2 MPa).

Further, the N₂ molecules that are trapped in the adsorption bed are desorbed by regenerating the adsorption bed. Desorption process utilizes both thermal energy and vacuum. Both the thermal energy and vacuum are used only for the desorption of N₂ and not for the adsorption process. Further, waste heat recovered from the WHR unit 220 provides the thermal energy 222 for regenerating the adsorption bed for N₂ desorption. The WHR unit 220 is coupled to the heating system of the VTSA subsystem 234 by insulated pipes. The waste heat from the WHR unit 220 can be transferred to the VTSA subsystem 234 via a heating fluid (water or oil) in coils or tubing. The heating fluid absorbs the thermal energy released in the WHR unit 220 and transfers it to the VTSA subsystem 234 via insulated tubing. In some implementations, the thermal energy is also supplied by external sources such as an electric heater or a microwave heater. In addition, the electricity generated by the DAFC can also be used to electrically heat the bed.

Vacuum that is used for the desorption process is generated by utilizing the electrical energy 216 produced by the DAFC 228. The vacuum is used for the desorption process to lower the partial pressure of the adsorbed gas, in this case N₂. The lower partial pressure accelerates the regeneration process.

The regeneration temperature of the adsorption bed ranges between 100-300°C. The adsorption bed regeneration temperature depends on the type of adsorbent material used, as described in FIG. 1. For example, carbon molecular sieves are regenerated at a temperature of about 100-250°C and a pressure of about 1.4-7 psi (0.01-0.05 MPa) below atmospheric pressure. Zeolites are regenerated at a temperature of about 100-300°C and a pressure of about 1.4-7 psi (0.01-0.05 MPa) below atmospheric pressure. MOFs are regenerated at a temperature of about 80-120°C and a pressure of about 1.4-7 psi (0.01-0.05 MPa) below atmospheric pressure. Upon regenerating the adsorption bed, the trapped N₂ molecules are released and flow as an effluent N₂ gas stream 236 through an outlet of the VTSA subsystem 234. The adsorption bed can be used for further adsorption-desorption cycles.

A combination of features that include flowing a low pressure gas mixture to the VTSA subsystem 234 for separation without needing further compression, the use of waste heat to provide thermal energy for the regeneration of the adsorption bed, and the use of electrical energy 216 to operate the vacuum pump in the VTSA subsystem 234 make the process energy efficient when compared to a PSA system.

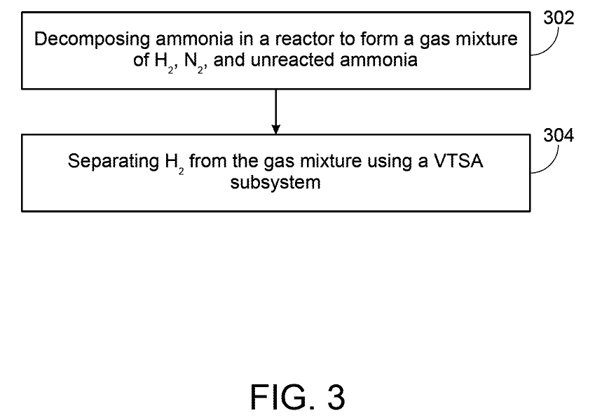

FIG. 3 is a flow chart of an example for ammonia cracking and gas separation. At block 302, gaseous ammonia at a low pressure of 7-30 psi (0.04-0.2 MPa) flows into a reactor where it undergoes a decomposition reaction to produce H₂, N₂, and unreacted ammonia. As described in FIG. 1, the reactor includes an electric reactor. The reactor receives electrical energy for its operation. The electrical energy which is transmitted to the reactor is generated by a DAFC. As described above, the DAFC uses the unreacted ammonia from the decomposition reaction and/or liquid ammonia from a storage tank as the fuel source to general electrical energy. The electrically powered reactor provides heat for the decomposition reaction.

In some implementations, the reactor for ammonia decomposition includes a membrane reactor. The membrane reactor uses a combination of a chemical reaction (ammonia decomposition) and in-situ gas separation (H₂ separation) within the reactor. As described in FIG. 2, the membrane reactor includes a proton conducting membrane supported on a ceramic base. The proton conducting membrane selectively allows H⁺ ions to pass through it. A further electrochemical reaction combines the H⁺ ions to produce a pure H₂ stream due to the electrochemical separation process. The electrical energy from the DAFC is transmitted to the reactor which is used to generate thermal energy for the ammonia decomposition reaction and also drive the electrochemical separation of H₂ gas.

At block 304, a VTSA subsystem receives a gas mixture that includes H₂ and N₂. The unreacted ammonia is separated using an ammonia separator for use as a fuel in the DAFC. Additionally, ammonia from a storage tank is also used as a fuel source for the DAFC. The pressure of the gas mixture flowing to the VTSA subsystem is low and ranges between 7-45 psi (0.04-0.3 MPa). No further compression is needed for gas separation. The VTSA subsystem includes an adsorption based process, which include several adsorption beds, a vacuum pump, a heating system, and gas flow valves. The adsorption bed in the VTSA subsystem adsorbs only N₂ gas due to the pore size of the adsorbent material and its selectivity. The H₂ gas flows as an effluent stream out of the VTSA subsystem.

Further, the N₂ gas is desorbed by regenerating the adsorption bed in the VTSA subsystem. The regeneration process utilizes thermal energy and vacuum for the desorption of N₂. A WHR coupled to the VTSA subsystem provides thermal energy for the regeneration process. The waste heat from the effluent gases from the electric reactor is recovered in the WHR to provide the thermal energy to the VTSA subsystem. The DAFC provides electrical energy for vacuum generation. After the desorption of N₂ from the adsorption bed, N₂ flows as a effluent stream out of the VTSA subsystem.

Implementations disclosed here provide an integrated system to implement an energy efficient process for the decomposition of low pressure ammonia and separation of the low pressure H₂ and N₂ gas mixture. The separation process uses VTSA instead of a conventional PSA system. The VTSA can be effectively utilized for separation of low pressure gases without requiring additional compression during the separation process. Further, thermal energy is recovered from the waste heat of the reactor’s effluent gas and supplied to the VTSA for gas separation. Additionally, electrical energy generated by the DAFC is used to operate the VTSA and power the reactor, making the overall system energy efficient for low pressure ammonia cracking and separation.

### Examples

Certain aspects of the subject matter disclosed here can be implemented as a gas separation method. The method includes decomposing ammonia at a low pressure in a reactor to form a gas mixture that includes N₂ and H₂, and separating H₂ from the gas mixture using a VTSA subsytem.

An aspect combinable with any other aspect includes the following features. The method of separation of H₂ from the gas mixture using the VTSA subsystem includes flowing the gas mixture to an ammonia separator at low pressure, where the ammonia separator is coupled to the VTSA subsystem. The N₂ is adsorbed from the gas mixture by an adsorbent bed in the VTSA subsystem, resulting in the H₂ as an effluent stream.

An aspect combinable with any other aspect includes the following features. The method further includes desorbing N₂ from the adsorbent bed using vacuum.

An aspect combinable with any other aspect includes the following features. The method further includes producing electrical energy by a DAFC and transmitting at least a portion of the electrical energy to the reactor and the VTSA subsystem.

An aspect combinable with any other aspect includes the following features. The method includes producing electrical energy by the DAFC, using unreacted ammonia from the ammonia separator as a fuel.

An aspect combinable with any other aspect includes the following features. The method includes recovering a portion of thermal energy from a waste heat recovery system to regenerate the adsorbent bed in the VTSA subsystem to desorb N₂.

An aspect combinable with any other aspect includes the following features. The thermal energy is generated by the waste heat recovery system using heat from the gas mixture exiting the reactor.

An aspect combinable with any other aspect includes the following features. The reactor includes an electric reactor or a membrane reactor.

An aspect combinable with any other aspect includes the following features. Decomposing ammonia at a low pressure occurs at about 7-30 psi (0.04-0.2 MPa).

Certain aspects of the subject matter disclosed here can be implemented as a gas separation method. The method includes separating H₂ from the gas mixture using a VTSA subsytem, where N₂ is absorbed by an adsorbent bed in the VTSA subsystem, resulting in H₂ as an effluent gas stream. The separation of N₂ from the adsorbent bed includes recovering a portion of thermal energy generated by a waste heat recovery system coupled to the VTSA subsystem and regenerating the adsorbent bed using the recovered thermal energy to desorb N₂.

An aspect combinable with any other aspect includes the following features. The method further includes using vacuum to desorb N₂ from the adsorbent bed of the VTSA subsystem.

An aspect combinable with any other aspect includes the following features. The thermal energy is generated by the waste heat recovery system using heat from the gas mixture exiting the reactor.

An aspect combinable with any other aspect includes the following features. The method further includes separating an in-situ formed H₂ stream by an electrochemical process during the decomposition of ammonia in the reactor. The H₂ stream is discharged from the reactor as an output stream. The output stream is combined with the separated H₂ stream from the VTSA subsystem.

An aspect combinable with any other aspect includes the following features. The method further includes operating the reactor using electrical energy generated by a DAFC, where ammonia from a storage tank or an unreacted ammonia from an ammonia separator is used as a fuel source for the DAFC.

An aspect combinable with any other aspect includes the following features. A portion of the electrical energy generated by the DAFC is transmitted to the VTSA subsystem.

An aspect combinable with any other aspect includes the following features. The method further includes flowing the gas mixture from the reactor to the VTSA subsystem at a low pressure for separating H₂, where the low pressure ranges between 7-30 psi (0.04-0.2 MPa).

Certain aspects of the subject matter disclosed here can be implemented as a hydrogen production method. The method includes decomposing ammonia in a reactor to form a gas mixture which includes N₂ and H₂, where the reactor is powered by at least a portion of electrical energy generated by a DAFC. The H₂ is separated from the gas mixture using a VTSA subsystem, where at least a portion of the electrical energy from the DAFC is transmitted to the VTSA subsystem.

An aspect combinable with any other aspect includes the following features. The separation of H₂ by the VTSA subsystem includes flowing the gas mixture from the reactor to an ammonia separator, where the ammonia separator is coupled to the VTSA subsystem. The ammonia is separated in the ammonia separator and a mixture of N₂ and H₂ is discharged to an adsorbent bed in the VTSA subsystem. The N₂ is adsorbed by the adsorbent bed and H₂ is flowed as an effluent stream.

An aspect combinable with any other aspect includes the following features. The method includes generating the electrical energy by the DAFC using the separated ammonia from the ammonia separator as a fuel source.

An aspect combinable with any other aspect includes the following features. The method includes separating N₂ from the adsorbent bed by recovering at least a portion of thermal energy from a waste heat recovery system, transmitting the portion of the thermal energy to the VTSA subsystem to regenerate the adsorbent bed to desorb N₂, and cooling the adsorbent bed using an N₂ produced in the DAFC by an electrochemical oxidation reaction.

Other implementations are also within the scope of the following claims.

1. A gas separation method comprising:
decomposing ammonia at a low pressure in a reactor to form a gas mixture comprising nitrogen (N₂) and hydrogen (H₂); and
separating H₂ from the gas mixture using a vacuum temperature swing adsorption (VTSA) subsytem.

2. The method of claim 1, wherein separating the H₂ from the gas mixture using the VTSA subsystem comprises:
flowing the gas mixture to an ammonia separator at low pressure, wherein the ammonia separator is coupled to the VTSA subsystem; and
adsorbing N₂ from the gas mixture by an adsorbent bed in the VTSA subsystem, resulting in the H₂ as an effluent stream.

3. The method of claim 2, further comprising desorbing N₂ from the adsorbent bed using vacuum.

4. The method of claim 1, further comprising producing electrical energy by a direct ammonia fuel cell (DAFC) and transmitting at least a portion of the electrical energy to the reactor and the VTSA subsystem.

5. The method of claim 4, wherein producing electrical energy by the DAFC comprises using unreacted ammonia from the ammonia separator as a fuel.

6. The method of claim 2, further comprising recovering a portion of thermal energy from a waste heat recovery system to regenerate the adsorbent bed in the VTSA subsystem to desorb N₂.

7. The method of claim 6, wherein generating, by the waste heat recovery system, thermal energy using heat from the gas mixture exiting the reactor.

8. The method of claim 1, wherein the reactor comprises an electric reactor or a membrane reactor.

9. The method of claim 1, wherein decomposing ammonia at low pressure occurs at about 7-30 pounds per square inch (psi) (0.04-0.2 Mega Pascals (MPa)).

10. A gas separation method comprising:
decomposing ammonia in a reactor to form a gas mixture comprising nitrogen (N₂) and hydrogen (H₂);
separating H₂ from the gas mixture using a vacuum temperature swing adsorption (VTSA) subsytem, wherein N₂ is absorbed by an adsorbent bed in the VTSA subsystem, resulting in H₂ as an effluent gas stream; and
separating N₂ from the adsorbent bed comprises:
recovering a portion of thermal energy generated by a waste heat recovery system coupled to the VTSA subsystem; and
regenerating the adsorbent bed using the thermal energy to desorb N₂.

11. The method of claim 10, further comprising using vacuum to desorb N₂ from the adsorbent bed of the VTSA subsystem.

12. The method of claim 10, wherein generating the thermal energy in the waste heat recovery system comprises using heat from the gas mixture exiting the reactor.

13. The method of claim 10, further comprising:
separating, by an electrochemical process, an in-situ formed H₂ stream (H₂ stream) during ammonia decomposition in the reactor;
discharging the H₂ stream from the reactor as an output stream; and
joining the output stream with the separated H₂ from the VTSA subsystem.

14. The method of claim 10, further comprising operating the reactor using electrical energy generated by a direct ammonia fuel cell (DAFC), wherein ammonia from a storage tank or an unreacted ammonia from an ammonia separator is used as a fuel source for the DAFC.

15. The method of claim 14, further comprising transmitting a portion of the electrical energy generated by the DAFC to the VTSA subsystem.

16. The method of claim 10, further comprising flowing the gas mixture from the reactor to the VTSA subsystem at a low pressure for separating H₂ wherein the low pressure ranges between 7-30 psi (0.04-0.2 MPa).

17. A hydrogen production method comprising:
decomposing ammonia in a reactor to form a gas mixture comprising nitrogen (N₂) and hydrogen (H₂), wherein the reactor is powered by at least a portion of electrical energy generated by a direct ammonia fuel cell (DAFC); and
separating H₂ from the gas mixture using a vacuum temperature swing adsorption (VTSA) subsytem, wherein at least a portion of the electrical energy from the DAFC is transmitted to the VTSA subsystem.

18. The method of claim 17, wherein separating H₂ by the VTSA subsystem comprises:
flowing the gas mixture from the reactor to an ammonia separator, wherein the ammonia separator is coupled to the VTSA subsystem;
separating ammonia in the ammonia separator and discharging a mixture of N₂ and H₂ to an adsorbent bed in the VTSA subsystem; and
adsorbing N₂ by the adsorbent bed and flowing H₂ as an effluent stream.

19. The method of claim 18, further comprising generating the electrical energy by the DAFC using the separated ammonia from the ammonia separator as a fuel source.

20. The method of claim 18, further comprising separating N₂ from the adsorbent bed by:
recovering at least a portion of thermal energy from a waste heat recovery system;
transmitting the portion of the thermal energy to the VTSA subsystem to regenerate the adsorbent bed to desorb N₂; and
after desorbing N₂ cooling the adsorbent bed using an N₂ produced in the DAFC by an electrochemical oxidation reaction.
